(19) United States
(12) Patent Application Publication
(10) Pub. No.: US 2026/0046239 A1
(43) Pub. Date: Feb. 12, 2026

(54) SATELLITE NETWORK DETERMINISTIC ROUTE CONSTRUCTION METHOD, FORWARDING METHOD, AND SYSTEM

(71) Applicant: BEIJING UNIVERSITY OF POSTS AND TELECOMMUNICATIONS, Beijing (CN)

(72) Inventors: Ran ZHANG, Beijing (CN); Xinyuan ZHANG, Beijing (CN); Jiang LIU, Beijing (CN); Zekun SUN, Beijing (CN); Shiran SUN, Beijing (CN)

(73) Assignee: BEIJING UNIVERSITY OF POSTS AND TELECOMMUNICATIONS, Beijing (CN)

(21) Appl. No.: 19/361,629

(22) Filed: Oct. 17, 2025

Related U.S. Application Data
(63) Continuation of application No. PCT/CN2023/108949, filed on Jul. 24, 2023.

(30) Foreign Application Priority Data
Apr. 21, 2023 (CN) 202310437219.7

(51) Int. Cl. H04L 45/121; H04L 41/12

(52) U.S. Cl. CPC H04L 45/121; H04L 41/12

(57) ABSTRACT

The present disclosure provides a satellite network deterministic route construction method, forwarding method, and system. The deterministic route construction method includes: according to service data and topology information of an entire satellite network, searching for a plurality of feasible paths from the source node to the destination node corresponding to the service data; according to transmission configuration information of the service data and the topology information of the entire satellite network, screening out, from the plurality of feasible paths, a feasible path satisfying a preset transmission demand as present target feasible path; and determining path overhead of each target feasible path, and selecting a feasible path with lowest path overhead as a deterministic forwarding path of the service data. The present disclosure can achieve specification of end-to-end path satisfying delay requirements and deterministic delay forwarding for delay-sensitive service data, thereby effectively reducing reconfiguration overhead, and realizing high scalability.

### CROSS-REFERENCE TO RELATED APPLICATIONS

This application is a continuation of International Application No. PCT/CN2023/108949, filed on Jul. 24, 2023, which claims priority to Chinese Patent Application No. CN202310437219.7 filed on Apr. 21, 2023, both of which are hereby incorporated by reference in their entireties.

### TECHNICAL FIELD

The present disclosure relates to the field of satellite network communication technologies, and in particular, to a satellite network deterministic route construction method, forwarding method, and system.

### BACKGROUND

A traditional satellite network has the characteristics of a wide coverage range, high survivability, or the like, and is widely used for providing communication services for remote areas or disaster-relief and emergency response scenarios. In recent years, with advancements in low-earth-orbit satellite technology-including reduced design cost, large-scale manufacturing capabilities, reduced launching cost, and improved satellite onboard performance development and application of the satellite networks embrace new opportunities,. and the satellite networks are used to provide ultra-reliable and low-delay communication services, such as large-scale Internet of Things (IoT) communication services, in the scenarios of industrial Internet of Things, agricultural automation, offshore drilling platforms, as well as satellite edge computing services.

Currently, numerous communication or Internet services adopt low-earth-orbit constellations, such as Starlink and the Iridium, for data transmission. However, the current low-earth-orbit constellations only provide non-deterministic end-to-end service capabilities, lack deterministic guarantees for indexes, such as bandwidth, delay, jitter and packet loss, which makes it difficult to support further popularization and development of the low-earth-orbit satellite networks. For example, when using satellite network for beyond-visual-range control of unmanned aerial vehicles (drones), the satellite network is required to support low-delay and high-reliability control signaling transmission. Taking communication from the unmanned aerial vehicles to ground stations as an example, it is required that the delay be less than 50 milliseconds, and in terms of reliability, a data packet error rate be lower than 10-3. Remote industrial Internet interconnection scenarios based on the satellite networks, such as remote implementation of a cloud programmable logic controller (PLC), and cross-regional factory interconnection, also impose deterministic requirements for the delay, the jitter and the reliability. Remote real-time video back transmission and interaction based on the satellite networks require larger bandwidth and less delay. For example, 360-degree 4K cloud VR video transmission requires bandwidth up to 20-40 Mbps and delay less than 50 ms. The above services with strong real-time and reliability demands impose requirements on the deterministic service capability of low-earth-orbit satellite networks.

In order to achieve the deterministic guarantee in the satellite networks, researchers put forward a route algorithm based on a time-varying continuous graph model in “Time-Varying Graph-based Space-Ground Integrated Network Time Deterministic Route Algorithm and Protocol” (Journal on Communications, October 2020, Vol. 41, No. 10, P116-129). Since a time-varying continuous graph can represent time-space attributes of multi-dimensional resources of the satellite networks, the calculated route has a time attribute to deterministically guarantee resource occupation at each moment. However, resource occupation calculation based on the time-varying continuous graph needs time integration, has extremely high calculation complexity and poor scalability, and therefore cannot be practically applied to end-to-end deterministic routing in the satellite networks. The method selects a network layer route from a control plane perspective and does not design traffic shaping and forwarding behaviors of a switch from a data plane perspective, and therefore, the method can only realize a deterministic service guarantee effect with coarser granularity. Some researchers have proposed distributing wireless time slots of inter-satellite links based on time division multiple access (TDMA) technology to realize inter-satellite deterministic scheduling without waiting and packet loss. However, in this technology, only the forwarding behavior of a single-hop inter-satellite link is designed in a low-earth-orbit satellite formation scenario, and an end-to-end multi-hop global deterministic service quality guarantee of the satellite network cannot be realized.

The current time deterministic network technology for ground networks supports a bounded deterministic transmission mechanism of delay and jitter-sensitive service traffic under different-scale networks, and a forwarding path and the queuing delay in each node are planned using technologies, such as the transmission sequence number (TSN) of a data link layer and the deterministic network (DetNet) of a network layer, so as to guarantee timely, on-time and cooperative reaching of end-to-end services. However, this technology cannot meet the demands of diversified satellite network services in large-scale satellite networks and the working requirements of spatial links with the characteristics of dynamic properties, long propagation delays, high error rates, or the like, is used for a small-scale local area network, is suitable for the periodic-small-packet TSN two-layer deterministic delay guarantee technology, and is not suitable for deterministic satellite networks. In addition, since research work of the DetNet is not yet fully mature, and coupled with the highly dynamic nature of satellite networks, the DetNet technology is unsuitable for the satellite deterministic networks.

In particular, current-phase providing of end-to-end time deterministic services by the low-earth-orbit satellite network still faces the following specific challenges: (1) propagation delay and transmission path changes caused by high-speed motion of the low-earth-orbit satellite greatly increase difficulty of providing the delay deterministic guarantee; (2) since the routing scheme distributed by a large space-time scale satellite network adopting a traditional real-time path inquiry and flow table based on a software defined network (SDN) causes limitation in network fine granularity agile management and control, Internet service transmission has the problems of large delays and limited scalability; moreover, route strategies are frequently updated due to topology changes, so that signaling overhead is greatly increased.

### SUMMARY

In view of this, embodiments of the present disclosure provide a satellite network deterministic route construction method, forwarding method, and system, so as to eliminate or improve one or more defects in the prior art.

In an aspect, the present disclosure provides a satellite network deterministic route construction method, including:
collecting in real-time transmission configuration information of service data to be transmitted in a satellite network, and topology information of the entire satellite network in a global view of the satellite network, and continuously recording change data of the global view of the satellite network; according to the service data and the topology information, searching for a plurality of feasible paths from a source node to a destination node corresponding to each piece of service data; according to the transmission configuration information of the service data, and the topology information of the entire satellite network, screening out, from the plurality of feasible paths, a feasible path satisfying a preset transmission demand as a present target feasible path; and determining path overhead of each target feasible path, and selecting a feasible path with lowest path overhead as a deterministic forwarding path of the service data.

In some embodiments of the present disclosure, the transmission configuration information of the service data includes: a long-term average rate of service data transmission, a maximum burst of service data transmission, an end-to-end delay requirement and a maximum length of service data packets of each priority.

In some embodiments of the present disclosure, the topology information of the satellite network includes:
a maximum bandwidth of an output port of each satellite node; a maximum distribution bandwidth of each priority queue in the output port of each satellite node; a credit value accumulation rate and a credit value sending rate of token buckets of each priority queue of a credit based shaper; a size of a maximum buffer area of each priority queue in the output port of each satellite node; and an inter-satellite node link propagation delay.

In some embodiments of the present disclosure, the according to the transmission configuration information of the service data, and the topology information of the entire satellite network, screening out, from the plurality of feasible paths, a feasible path satisfying a preset transmission demand as a present target feasible path includes:
determining whether a total delay required by forwarding the service data according to each of the plural feasible paths meets an end-to-end delay requirement of the service data from the source node to the destination node; the total delay required by forwarding the service data including: a sum of maximum delays of the priority queues passing through the satellite nodes and a sum of inter-satellite node propagation delays; if feasible paths meeting the end-to-end delay requirement of forwarding of the service data exist, determining whether a bandwidth resource required by forwarding the service data according to each of the feasible paths meeting the end-to-end delay requirement of forwarding of the service data meets the maximum distribution bandwidth of the priority queue of each satellite node; the bandwidth resource being used for representing a sum of an occupied bandwidth of the priority queue of each satellite node through which the service data is forwarded and an average rate of forwarding of the service data; if feasible paths meeting the maximum distribution bandwidth of the priority queue of each satellite node exist, determining whether a buffer area resource required by forwarding the service data according to each of the feasible paths meeting the maximum distribution bandwidth of the priority queue of each satellite node meets a maximum distribution buffer area of the priority queue of each satellite node; the buffer area resource being used for representing a sum of a size of a buffer area occupied by the priority queue of each satellite node through which the service data is forwarded and the maximum burst of service data transmission; and screening out feasible queues meeting the end-to-end delay requirement of forwarding of the service data, the maximum distribution bandwidth of the priority queue of each satellite node and the maximum distribution buffer area of the priority queue of each satellite node.

In some embodiments of the present disclosure, the according to the transmission configuration information of the service data, and the topology information of the entire satellite network, screening out, from the plurality of feasible paths, a feasible path satisfying a preset transmission demand as a present target feasible path further includes: sequentially screening out, from the plural feasible paths, the feasible paths satisfying the preset transmission demand of the service data according to an ascending order of the total propagation delays of the feasible paths.

In some embodiments of the present disclosure, the determining path overhead of each target feasible path includes: calculating a difference of the size of the occupied buffer area of a specified priority queue in the satellite node before and after the target feasible path is mapped to the specified priority queue; dividing the difference by the size of the maximum distribution buffer area of the specified priority queue and then the maximum burst of the service data transmission to obtain path overhead of the specified priority queue; and calculating a sum of the path overhead of the priority queues specified in the satellite nodes indicated in the target feasible path to obtain the path overhead of the target feasible path.

In a second aspect, the present disclosure provides a satellite network deterministic route forwarding method, including:
executing the above satellite network deterministic route construction method to obtain the deterministic forwarding path of the service data; issuing a service data packet carrying the service data and the deterministic forwarding path of the service data to the source node of the service data, and deducting, in the global view, the occupied bandwidth and the occupied buffer area on the priority queue specified in each satellite node through which the deterministic forwarding path of the service data passes; after each satellite node specified by the deterministic forwarding path forwards the service data according to the deterministic forwarding path to forward the service data from the source node to the destination node, re-releasing, in the global view, the bandwidth and the buffer area occupied on the priority queue specified in each satellite node through which the deterministic forwarding path of the service data passes.

In a third aspect, the present disclosure provides a satellite network deterministic route forwarding method, including:
receiving a service data packet carrying service data and a deterministic forwarding path of the service data which are sent by a controller of a satellite network, wherein the deterministic forwarding path of the service data is obtained by the controller in advance based on the above satellite network deterministic route construction method; if a satellite node is determined to be a source satellite node corresponding to the service data according to the deterministic forwarding path, performing label stack pushing on the received service data packet, and pressing the deterministic forwarding path of the service data into the header of the service data packet in a label stack form; according to a priority of the service data, adding the service data packet with the service data into a specified priority queue; forwarding the service data packet to a next satellite node designated by the deterministic forwarding path according to a credit shaping algorithm; and completing forwarding of the service data packet after the service data packet is forwarded to the destination node.

In another aspect, the present disclosure provides a satellite network deterministic route system, including a processor and a memory, wherein the memory has computer instructions stored therein, the processor is configured to execute the computer instructions stored in the memory, and the system implements the steps of the above satellite network deterministic route construction method, the above satellite network deterministic route forwarding method of the second aspect, or the above satellite network deterministic route forwarding method of the third aspect, when the computer instructions are executed by the processor.

In another aspect, the present disclosure provides a computer-readable storage medium having a computer program stored thereon, wherein the program, when executed by a processor, implements the steps of the above satellite network deterministic route construction method, the above satellite network deterministic route forwarding method of the second aspect, or the above satellite network deterministic route forwarding method of the third aspect.

In a high dynamic satellite network with topological connectivity hopping and a link propagation delay gradually changing, the satellite network deterministic route construction method, forwarding method, and system according to the present disclosure realize construction of the end-to-end deterministic path meeting the delay requirement for the delay-sensitive service data, and meanwhile consider occupation of the limited satellite resource on each satellite node and the buffer area of the satellite node, thus effectively avoiding the influence of uncertain factors, such as the overflow or loss of the service data packet; the disclosure is suitable for the condition of high-speed periodic changes of a large-scale satellite network, can effectively reduce a large amount of reconfiguration overhead and has high scalability.

Additional advantages, objects and features of the present disclosure will be set forth in part in the description which follows and in part will become apparent to those having ordinary skill in the art upon examination of the following or may be learned from practice of the present disclosure. The objects and other advantages of the present disclosure will be achieved and attained by the structure particularly pointed out in the specification and drawings.

It will be appreciated by those skilled in the art that the objects and advantages that can be achieved with the present disclosure are not limited to what has been particularly described hereinabove, and that the above and other objects that can be achieved with the present disclosure will be more clearly understood from the following detailed description.

### BRIEF DESCRIPTION OF THE DRAWINGS

The accompanying drawings described herein are used to provide a further understanding of the present disclosure, constitute a part of the present application, and do not limit the present disclosure.

FIG. 1 is a flow chart of satellite network deterministic route construction.

FIG. 2 shows subtraction of a service curve function of a priority queue from an arrival curve function of the priority queue.

FIG. 3 is a flow chart of selection of a deterministic forwarding path from a plurality of feasible paths.

### DETAILED DESCRIPTION

In order to make the objects, technical solutions and advantages of the present disclosure more apparent, the present disclosure is described in further detail below with reference to the embodiments and the accompanying drawings. Herein, the exemplary embodiments of the present disclosure and the descriptions thereof are used to explain the present disclosure, but not to limit the present disclosure.

It should also be noted herein that, in order to avoid obscuring the present disclosure with unnecessary details, only the structures and/or processing steps closely related to the solution according to the present disclosure are shown in the drawings, and other details not so related to the present disclosure are omitted.

It should be emphasized that the term “includes/comprises” when used herein, is taken to specify the presence of features, elements, steps or components, but does not preclude the presence or addition of one or more other features, elements, steps or components.

Here, it is also noted that, unless otherwise specified, the term “connected” is used herein to refer not only to direct connection, but also to indirect connection with an intermediate.

Hereinafter, embodiments of the present disclosure will be described with reference to the drawings. In the drawings, the same reference numerals denote the same or similar components or the same or similar steps.

In order to solve the problem in the prior art that constant changes in propagation delay and transmission paths of a satellite network due to high-speed periodic motion of a low-earth-orbit satellite in satellite networks make it difficult to guarantee delay certainty in end-to-end data transmission, the present disclosure proposes a satellite network deterministic route construction method performed by a controller of the satellite network, as shown in FIG. 1, including the following steps:
step S110: collecting transmission configuration information of service data to be transmitted in a satellite network, and topology information of the entire satellite network in a global view of the satellite network in real-time, and continuously recording change data of the global view of the satellite network.

The transmission configuration information of the service data to be transmitted includes: a long-term average rate of service data fᵢ transmission, a maximum burst bᵢ of service data transmission, an end-to-end delay requirement Tᵢ and a maximum length Lₓ^{max} of service data packets of each priority. The topology information of the entire satellite network includes: the maximum bandwidth of output ports of each satellite node; a maximum distribution bandwidth of each priority queue in the output port of each satellite node; a credit value accumulation rate idleSlope and a credit value sending rate sendSlope of token buckets of each priority queue of a credit based shaper (CBS) in each satellite node; size of a maximum buffer area of each priority queue in the output port of each satellite node; and an inter-satellite node link propagation delay; the CBS divides service data transmission queues of each satellite node into a class A (strict delay bound) priority queue and a class B (loose delay bound) priority queue.

The continuously recording change data of the global view of the satellite network includes: obtaining time-varying data of the global view of the satellite network according to a satellite operation rule shown by an ephemeris of the satellite network on the basis of the topology information of the entire satellite network in the global view of the satellite network collected in real time.

The global view of the satellite network is recorded in real time in the above step S110, so that single-hop maximum delays of the class A priority queue and the class B priority queue of each satellite node are calculated according to the global view of the satellite network, and a calculation basis is provided for a deterministic route of the satellite network, the single-hop maximum delay including a processing delay, a queuing delay and a forwarding delay.

Step S120: according to the service data and the topology information, searching for a plurality of feasible paths from a source node to a destination node corresponding to each piece of service data.

The above step S120 further includes: when the service data to be transmitted reaches the controller of the satellite network, using a shortest path algorithm in the controller of the satellite network to calculate the feasible paths between the source node and the destination node of the service data, that is, taking the transmission configuration information of the service data to be transmitted and the topology information of the satellite network as input information of the shortest path algorithm, searching for the feasible paths between the source node and the destination node of the service data to be transmitted by the shortest path algorithm on the basis of the priority queue in the topology information of the satellite network, and outputting the plurality of feasible paths of the service data to be transmitted by the shortest path algorithm.

Step S130: according to the transmission configuration information of the service data, and the topology information of the entire satellite network, screening out, from the plurality of feasible paths, a feasible path satisfying a preset transmission demand as a present target feasible path.

In the step S130, the feasible paths which meet the transmission demand of the service data to be transmitted from the source node to the destination node are sequentially screened out according to an ascending sequence of the total propagation delays of the feasible paths. The preset transmission demands include an end-to-end delay requirement of forwarding of the service data, the maximum distribution bandwidth of the priority queue of each satellite node and the size of a maximum distribution buffer area of the priority queue of each satellite node. The above step S130 includes the following steps: determining whether a total delay required by forwarding the service data according to each of the plural feasible paths meets the end-to-end delay requirement of the service data from the source node to the destination node; the total delay required by forwarding the service data to be transmitted including: a sum of maximum delays of the priority queues passing through the satellite nodes and a sum of inter-satellite node propagation delays; if feasible paths meeting the end-to-end delay requirement of forwarding of the service data exist, determining whether a bandwidth resource required by forwarding the service data according to each of the feasible paths meeting the end-to-end delay requirement of forwarding of the service data meets the maximum distribution bandwidth of the priority queue of each satellite node; as an example, the bandwidth resource being used for representing a sum of an occupied bandwidth of the priority queue of each satellite node through which the service data is forwarded and an average rate of forwarding of the service data; if feasible paths meeting the maximum distribution bandwidth of the priority queue of each satellite node exist, determining whether a buffer area resource required by forwarding the service data according to each of the feasible paths meeting the maximum distribution bandwidth of the priority queue of each satellite node meets the maximum distribution buffer area of the priority queue of each satellite node; as an example, the buffer area resource being used for representing a sum of a size of a buffer area occupied by the priority queue of each satellite node through which the service data is forwarded and the maximum burst of service data transmission. Feasible queues meeting the end-to-end delay requirement of forwarding of the service data, the maximum distribution bandwidth of the priority queue of each satellite node and the maximum distribution buffer area of the priority queue of each satellite node are screened out.

Step S140: determining path overhead of each target feasible path, and selecting a feasible path with lowest path overhead as a deterministic forwarding path of the service data.

The step of calculating the path overhead of each target feasible path includes: calculating a difference of the size of the occupied buffer area of a specified priority queue in the satellite node before and after the target feasible path is mapped to the specified priority queue:

$${B}_{new}^{n , x} - {U}_{B}^{n , x} ; wherein {B}_{new}^{n , x}$$

represents the size of the occupied buffer area of the specified priority queue of the satellite node after the service data to be transmitted is mapped to the specified priority queue in the satellite node,

$${B}_{B}^{n , x}$$

represents the size of the occupied buffer area of the specified priority queue of the satellite node before the service data to be transmitted is mapped to the specified priority queue in the satellite node, and n=1, 2, 3 . . . represents the serial number of the satellite node; x represents the specified priority queue in the satellite node; dividing the difference by the size of the maximum distribution buffer area of the specified priority queue and then the maximum burst of the service data transmission to obtain path overhead of the specified priority queue in the satellite node; and calculating a sum of the path overhead of the priority queues specified in the satellite nodes indicated in the target feasible path to obtain the path overhead of the target feasible path:

$$\frac{{B}_{n e w}^{n , x} - {U}_{B}^{n , x}}{{A}_{B}^{n , x} \cdot {b}_{n e w}} , wherein {A}_{B}^{n , x}$$

represents the maximum distribution buffer area of the priority queue x in the satellite node n; b_{new} represents the maximum burst of the service data to be transmitted.

A method for calculating

$${B}_{n e w}^{n , x}$$

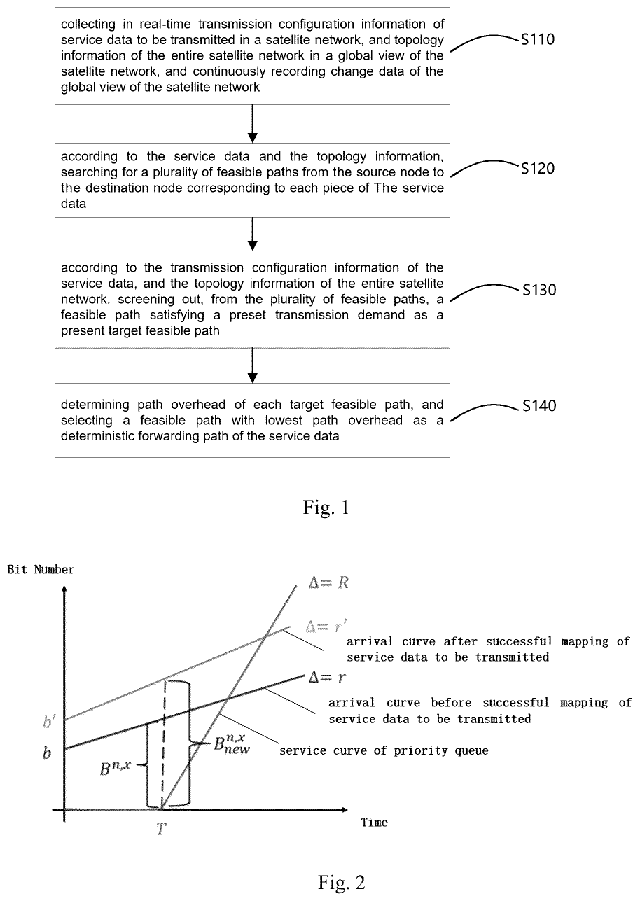

includes: after new service data to be transmitted arrives, subtracting a service curve function of the priority queue from an arrival curve function of the priority queue to generate a difference function, wherein the maximum value of the difference function is the occupied buffer area of the priority queue after the service data to be transmitted is successfully mapped to the specified priority queue in the satellite node. As shown in FIG. 2, r is an arrival rate of an arrival curve before mapping of the service data to be transmitted, b is a maximum burst of the arrival curve before mapping of the service data to be transmitted, r′ is an arrival rate of the arrival curve after mapping of the service data to be transmitted, b′ is a maximum burst of the arrival curve after mapping of the service data to be transmitted, R is a service rate of the specified priority queue, and T is a waiting service time of the specified priority queue.

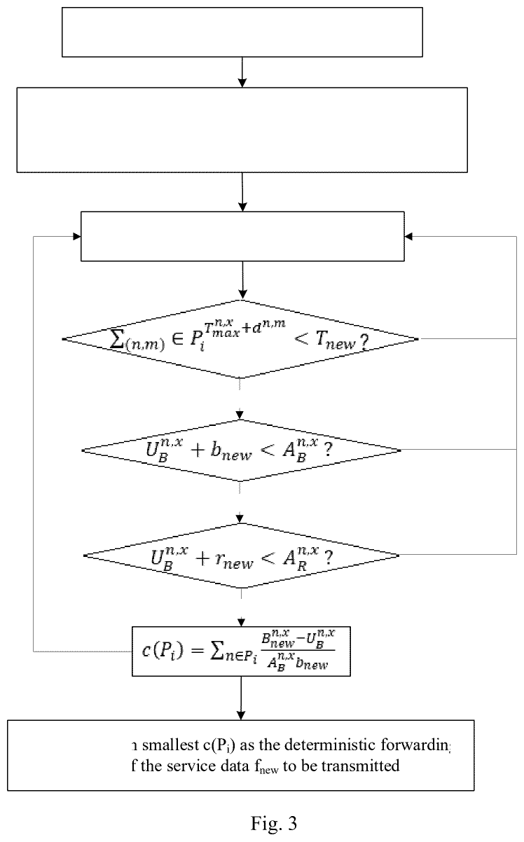

In an embodiment, the deterministic forwarding path for transmitting the service data to be transmitted is selected from the plurality of feasible paths by using a satellite network deterministic route construction system, the above steps S130 to S140 are executed in the satellite network deterministic route construction system, and the process shown in FIG. 3 is sequentially executed for the plural found feasible paths from the source node to the destination node corresponding to the service data according to the ascending order of the propagation delays, the process including:
step S131: sending the service data f_{new} to be transmitted to the satellite network deterministic route construction system, and the system using the shortest path algorithm to search for the plurality of feasible paths between the source node and the destination node of the service data to be transmitted on the basis of the priority queue, so as to obtain a feasible path set P_{new} including the plural feasible paths, and sequentially performing the following steps on the feasible paths in the feasible path set according to the ascending order of the propagation delays indicated by the shortest path algorithm.

Step S132: judging whether the sum

$$( {\sum }_{( n , m ∈ {P}_{i} )} {T}_{max}^{n , x} + {d}^{n , m} )$$

of the maximum delay

$${T}_{max}^{n , x }$$

of the corresponding priority queue of each passing satellite node and the propagation delay d^{n,m} between the passing satellite nodes is smaller than the end-to-end delay requirement T_{new} of forwarding of the service data to be transmitted when the service data to be transmitted is forwarded according to the current feasible path, if not, giving up the current feasible path, and repeatedly performing judgment of the current step S132 on the next feasible path; wherein n represents the current satellite node, m represents a neighboring node of the satellite node n, and x represents the priority queue in the satellite node.

Step S133: for the current feasible path that is judged to meet the end-to-end delay requirement of forwarding of the service data to be transmitted in the above step S132, judging whether the sum of the occupied bandwidth

$${U}_{B}^{n , x}$$

in the priority queue of each passing satellite node and the long-term average rate r_{new} of the service data to be transmitted is less than the maximum distribution bandwidth

$${A}_{R}^{n , x}$$

of the priority queue of each corresponding satellite node when the service data to be transmitted performs route forwarding according to the current feasible path, if not, abandoning the current feasible path, and repeatedly performing the judgment steps from the step S132 on the next feasible path.

Step S134: for the current feasible path that is judged to satisfy the maximum distribution bandwidth of the priority queue of each satellite node in the above step S133, judging whether the sum of the occupied buffer area

$${U}_{B}^{n , x}$$

in the priority queue of each passing satellite node and the maximum burst b_{new} of the service data to be transmitted is smaller than the maximum distribution buffer area

$${A}_{B}^{n , x}$$

of the priority queue of each corresponding satellite node when the service data to be transmitted performs route forwarding according to the current feasible path; if not, abandoning the current feasible path, and repeatedly performing the judgment steps from the step S132 on the next feasible path.

Step S141: calculating the path overhead c(Pᵢ) of the current feasible path that is judged to satisfy the size of the maximum distribution buffer area of the priority queue of each satellite node in the step S134:

$$c ( {P}_{i} ) = {\sum }_{n ∈ {P}_{i}} \frac{{B}_{new}^{n , x} - {U}_{B}^{n , x}}{{A}_{B}^{n , x} {b}_{n e w}} .$$

Step S142: selecting the feasible path with the lowest path overhead from all the feasible paths as the finally determined deterministic forwarding path of the service data f_{new} to be transmitted.

In a high dynamic satellite network with topological connectivity hopping and a link propagation delay gradually changing, the deterministic route construction method of the present application realizes specification of the end-to-end path meeting the delay requirement and deterministic forwarding for the delay-sensitive service data, and at the stage of determining the end-to-end feasible path meeting the delay requirement of the service data, occupation of the limited satellite resource on each satellite node and the buffer area of the satellite node are considered, thus effectively avoiding the influence of uncertain factors, such as the overflow or loss of the service data packet. For the case of frequent changes of a large-scale satellite network, when a segment routing (SR) mechanism is adopted, a large amount of reconfiguration overhead can be avoided only by performing configuration before the service data is transmitted, and high scalability is realized.

The present disclosure further proposes a first satellite network deterministic route forwarding method which can be executed by a controller of a satellite network. The method includes the following steps S210-S240:
step S210: executing the above satellite network deterministic route construction method to obtain the deterministic forwarding path of the service data.

Step S220: sending a service data packet carrying the service data and the deterministic forwarding path of the service data to the source node of the service data, and deducting, in the global view, the occupied bandwidth and the size of the occupied buffer area on the priority queue specified in each satellite node through which the deterministic forwarding path of the service data passes.

Since the satellite network is a continuously changing high dynamic satellite network, the accessed satellites corresponding to each ground controller change at intervals, the source node of the service data sent by the controller is uniquely determined within a period of time. In the above step S220, the deterministic forwarding path of the service data is issued from the controller of the satellite network to the source node of the service data in the form of a SR label stack.

When one piece of service data is transmitted according to the deterministic forwarding path in the satellite network, the controller receives one piece of service data to be transmitted, and in the above step S220, the occupied bandwidth and the size of the occupied buffer area on the priority queue specified in each satellite node through which the deterministic forwarding path of the service data passes are deducted in the global view, so that performability of the deterministic forwarding path of the current service data to be transmitted constructed by the controller can be ensured, and the condition that congestion of the satellite network is caused by data stacking in the transmission process of the previous service data and the transmission process of the current service data to be transmitted can be avoided.

The above step S220 further includes: for the source node of the service data, calculating a connection path of the satellite node under all topology snapshots within a period of transmission of the service data from the controller to the source node, so as to ensure that the connection path and the transmission delay of the satellite node are determined within the period of transmission of the service data from the controller to the source node. The topology snapshots are static network topologies divided at a fixed time interval by adopting a snapshot idea for a dynamic network topology, so that the satellite network in the fixed time interval corresponding to each topology snapshot is assumed to be static, and a connection relationship, a distance and the path of the service data from the source node to the destination node between the satellite nodes are unchanged under each topology snapshot.

Step S230: after each satellite node specified by the deterministic forwarding path forwards the service data according to the deterministic forwarding path to forward the service data from the source node to the destination node, re-releasing, in the global view, the bandwidth and the buffer area occupied on the priority queue specified in each satellite node through which the deterministic forwarding path of the service data passes.

Since the transmission process of one piece of service data is completed, the bandwidth and buffer area resources occupied by the service data in the transmission process are all released, so that the resource occupation of the service data in the global view can be released through the process of re-releasing, in the global view in the step S230, the bandwidth and the buffer area occupied on the priority queue specified in each satellite node through which the deterministic forwarding path of the service data passes, available resources of each satellite node in the satellite network is improved, and waste of data transmission resources in the satellite network is avoided.

According to the priority level of the service data, the service data packet with the service data is added into the specified priority queue.

The service data packet is forwarded to a next satellite node specified by the deterministic forwarding path according to a credit shaping algorithm; and forwarding of the service data packet is completed after the service data packet is forwarded to the destination node.

The present disclosure further provides a satellite network deterministic route forwarding method which can be executed by a satellite node in a satellite network, and the method includes the following steps S310-S340:
step S310: receiving a service data packet carrying service data and a deterministic forwarding path of the service data which are sent by the controller of the satellite network, wherein the deterministic forwarding path of the service data is obtained by the controller in advance based on the above satellite network deterministic route construction method;
step S320: if the current satellite node determines itself to be the source satellite node corresponding to the service data according to the deterministic forwarding path, performing label stack pushing on the received service data packet, and encapsulating the deterministic forwarding path of the service data into the header of the service data packet in the form of a label stack;
step S330: according to the priority of the service data, adding the service data packet with the service data into a specified priority queue;
step S340: forwarding the service data packet to the next satellite node designated by the deterministic forwarding path according to a credit shaping algorithm; and completing forwarding of the service data packet after the service data packet is forwarded to the destination node.

As an example, the credit shaping algorithm is a credit based shaper (CBS) transmission selection algorithm, is a traffic shaping technology defined by the priority, and defines the sending time interval and the size of a sending frame of the service data in the satellite node, and when transmission of the service data in a plurality of priority queues in the same satellite node conflicts, the sending interval and the sending data amount of the service data in each priority queue are distributed fairly, thereby avoiding a traffic burst caused by aggregation of the service data packets in the plural priority queues at the outlet end of the satellite node.

In the above step S340, the forwarding the service data packet to the next satellite node designated by the deterministic forwarding path according to a credit shaping algorithm includes: defining a credit value for the service data packet in each priority queue in each satellite node, and transmitting the service data packet in each satellite node according to a priority rule of each priority queue in the satellite node and the credit value of each priority queue. The credit value of each priority queue changes according to a transmission state of the service data packet in the priority queue, the credit value which can be used for transmission currently in each priority queue of each satellite node is credit in bit; a credit value increase rate of each priority queue of each satellite node is idleSlope in bit/s, and the value of the credit value increase rate idleSlope is smaller than a transmission rate portTransmitRate of the output port of the corresponding satellite node; a credit value decrease rate of each priority queue of each satellite node is sendSlope in bit/s, and sendSlope=idleSlope−portTransmitRate.

The transmission of the service data to be transmitted in each satellite node according to the priority rule of each priority queue in the satellite node and the credit value of each priority queue includes the following working conditions:
when control class data to be transmitted exists in the satellite node, the control class data is used as data with a highest priority, the output port of the satellite node firstly transmits the control class data to be transmitted, and meanwhile the credit values of other priority queues are kept unchanged. When the service data packets to be transmitted exist in a plurality of priority queues in the satellite node, the service data packets to be transmitted in the priority queues are transmitted in sequence according to the priority rule of the priority queues. When the service data packet to be transmitted exists in one priority queue in the satellite node, under the condition that the output port of the satellite node is in an idle state and the credit value of the priority queue is greater than or equal to 0, the service data packet to be transmitted in the priority queue is transmitted by the output port of the satellite node.

In an embodiment, the satellite node transmits the service data packet according to the credit shaping algorithm, and when data transmission is started, the credit value credit of each priority queue in the satellite node is 0, which specifically includes the following conditions.

First condition: when the service data packet to be transmitted exists in one priority queue in the satellite node, if no service data packet is transmitted in the satellite node and no service data of a higher priority queue waits for transmission, the service data packet to be transmitted in the priority queue immediately starts to be transmitted, and meanwhile, the credit value credit of the priority queue is continuously decreased at the rate sendSlope, and after the transmission of the service data packet is completed, the credit value of the priority queue is smaller than 0, and then the credit value credit of the priority queue is continuously increased at the rate idleSlopee until the credit value credit of the priority queue is increased to 0, thus the service data packet to be transmitted in the priority queue can be continuously transmitted.

Second condition: when one service data packet to be transmitted exists in one priority queue in the satellite node, if one conflicting service data packet which is transmitted exists at the output port in the satellite node, the service data packet to be transmitted in the priority queue needs to wait for the transmission of the conflicting service data packet, and meanwhile, the credit value credit of the priority queue is continuously increased at the rate idleSlope until the transmission of the conflicting service data packet is finished; at this point, the credit value credit of the priority queue is greater than 0, the service data packet to be transmitted in the priority queue immediately gets into a transmission state, and meanwhile, the credit value of the priority queue is continuously reduced at the rate sendSlope until the service data packet to be transmitted in the priority queue is completely transmitted; and if the credit value credit of the priority queue is still greater than 0 and no service data packet to be transmitted exists in the priority queue, the credit value credit of the priority queue is set to be 0.

Third condition: when a plurality of service data packets to be transmitted exist in one priority queue in the satellite node, if one conflicting service data packet which is transmitted exists at the output port in the satellite node, the service data packets to be transmitted in the priority queue need to wait for the transmission of the conflicting service data packet, and the credit value credit of the priority queue is continuously increased at the rate idleSlope until the transmission of the conflicting service data packet is finished; at this point, the credit value credit of the priority queue is greater than 0, the service data packets to be transmitted in the priority queue immediately get into a transmission state, and meanwhile, the credit value of the priority queue is continuously reduced at the rate sendSlope, and if after one of the service data packets to be transmitted is completely transmitted, the credit value credit of the priority queue is reduced to a negative number, the priority queue does not meet the condition of data transmission, then the credit value credit of the priority queue is continuously increased at the rate idleSlope until the credit value credit of the priority queue recovers to 0, and at this point, the remaining service data packets to be transmitted in the priority queue are continuously transmitted, and meanwhile, the credit value credit of the priority queue is continuously decreased at the rate sendSlope, and the credit value credit of the priority queue is decreased to a negative number; the above process of transmitting the service data packets to be transmitted in the priority queue is repeated until no service data packet to be transmitted exists in the priority queue, and thereafter, the credit value credit of the priority queue is continuously increased to 0 at the rate idleSlope.

Fourth condition: when the service data packets to be transmitted exist in a plurality of priority queues in the satellite node, the service data packets to be transmitted in the priority queues are transmitted in sequence according to the priority rule of the priority queues, and the process for transmitting the service data packet to be transmitted in each priority queue is shown in the above first condition to third condition.

Fifth condition: when the control class data to be transmitted exists in the satellite node, the control class data is used as the data with the highest priority, the output port of the satellite node firstly transmits the control class data to be transmitted, and meanwhile, the credit values of other priority queues are kept unchanged; after the transmission of the control class data to be transmitted is completed, the service data packets to be transmitted in the priority queues in the satellite node are transmitted corresponding to the above first condition to fourth condition.

In the present application, through the above deterministic route forwarding method, in the stage of performing end-to-end deterministic forwarding on the service data packet, by means of the traffic shaping mechanism based on the credit value, the problems that the service data packets to be transmitted of plural different priority queues are gathered at the output port of the satellite node, so that the buffer area of the output port of each satellite node in the deterministic forwarding path is overloaded, and then, the deterministic guarantee of the end-to-end delay cannot be provided for the delay-sensitive data can be solved effectively; and then, requirements of the data transmission process for a switch can be effectively reduced, a retrofitting cost is low, and high feasibility is achieved.

The present application further provides a controller of a satellite network configured to execute all or a part of the satellite network deterministic route construction method and/or the first satellite network deterministic route forwarding method, an embodiment of the controller may be specifically configured to execute the processing flow of the embodiments of the satellite network deterministic route construction method and/or the first satellite network deterministic route forwarding method in the foregoing embodiments, functions of the controller are not repeated herein, and reference may be made to the detailed descriptions of the embodiments of the satellite network deterministic route construction method and/or the first satellite network deterministic route forwarding method.

The controller may perform, in a server or a client device, a part of the satellite network deterministic route construction method and/or the first satellite network deterministic route forwarding method. Specific selection may be performed according to a processing capability of the client device, a limitation of a user usage scenario, or the like. The present application has no limitations in this regard. If all operations are completed in the client device, the client device may further include a processor for specific processing of the satellite network deterministic route construction method and/or the first satellite network deterministic route forwarding method.

The client device may have a communication module (i.e., a communication unit) and may be communicatively connected to a remote server to implement data transmission with the server. The server may include a server on a task scheduling center side, and in other implementation scenarios, the server may further include a server of an intermediate platform, for example, a server of a third-party server platform communicatively linked with the task scheduling center server. The server may include a single computer device, or may include a server cluster formed by a plurality of servers, or has a distributed server structure.

The server and the client device may be communicated using any suitable network protocol, including network protocols not developed at the filing date of the present application. The network protocol may include, for example, a TCP/IP protocol, a UDP/IP protocol, an HTTP protocol, an HTTPS protocol, or the like. Certainly, the network protocol may further include, for example, a remote procedure call (RPC) protocol, a representational state transfer (REST) protocol, or the like, used above the above protocol.

The present application further provides a satellite node for executing all or a part of the second satellite network deterministic route forwarding method, an embodiment of the satellite node may be specifically configured to execute the processing flow of the embodiment of the second satellite network deterministic route forwarding method in the foregoing embodiment, functions of the satellite node are not repeated herein, and reference may be made to the detailed description of the embodiment of the second satellite network deterministic route forwarding method.

Corresponding to the above method, the present disclosure further provides a satellite network deterministic route system, including a computer device including a processor and a memory, wherein the memory has computer instructions stored therein, the processor is configured to execute the computer instructions stored in the memory, and when the computer instructions are executed by the processor, the system implements the steps of the above satellite network deterministic route construction method, the above first satellite network deterministic route forwarding method which can be executed by the controller of the satellite network, or the above second satellite network deterministic route forwarding method which can be executed by the satellite node of the satellite network.

Embodiments of the present disclosure further provide a computer-readable storage medium having a computer program stored thereon, wherein the computer program, when executed by a processor, implements the steps of the above satellite network deterministic route construction method, the above first satellite network deterministic route forwarding method which can be executed by the controller of the satellite network, or the above second satellite network deterministic route forwarding method which can be executed by the satellite node of the satellite network. The computer-readable storage medium may be a tangible storage medium, such as a random access memory (RAM), a memory, a read only memory (ROM), an electrically programmable ROM, an electrically erasable programmable ROM, a register, a floppy disk, a hard disk, a removable storage disk, a CD-ROM, or any other form of storage medium known in the art.

Those of ordinary skill in the art should appreciate that the various exemplary components, systems and methods described in connection with the embodiments disclosed herein may be implemented in hardware, software, or combinations thereof. Whether they are implemented in hardware or software depends upon particular applications and design constraints of the technical solution. Professionals may use different methods for particular applications to achieve the described functions, but such implementations should not be considered beyond the scope of the present disclosure. When implemented in hardware, the elements of the present disclosure may be, for example, an electronic circuit, an application specific integrated circuit (ASIC), suitable firmware, plug-in, a function card, or the like. When implemented in software, the elements of the present disclosure are programs or code segments used to perform required tasks. The programs or the code segments can be stored in a machine-readable medium or transmitted by a data signal carried in a carrier wave over a transmission medium or a communication link.

It is to be understood that the present disclosure is not limited to the particular configurations and processing described above and shown in the drawings. A detailed description of known methods is omitted herein for the sake of brevity. In the above embodiments, several specific steps are described and shown as an example. However, the method processes of the present disclosure are not limited to the specific steps described and shown, and those skilled in the art can make various changes, modifications and additions, or change the order between the steps, after comprehending the spirit of the present disclosure.

Features that are described and/or illustrated with respect to one embodiment may be used in the same way or in a similar way in one or more other embodiments and/or in combination with or instead of the features of the other embodiments in the present disclosure.

The above description is only a preferred embodiment of the present disclosure and is not intended to limit the present disclosure, and various modifications and changes may be made to the embodiment of the present disclosure by those skilled in the art. Any modifications, equivalents and improvements made within the spirit and principle of the present disclosure should be included in the protection scope of the present disclosure.

1. A satellite network deterministic route construction method, comprising:
collecting in real-time transmission configuration information of service data to be transmitted in a satellite network, and topology information of the entire satellite network in a global view of the satellite network, and continuously recording change data of the global view of the satellite network;
according to the service data and the topology information, searching for a plurality of feasible paths from the source node to the destination node corresponding to each piece of the service data;
according to the transmission configuration information of the service data, and the topology information of the entire satellite network, screening out, from the plurality of feasible paths, a feasible path satisfying a preset transmission demand as a present target feasible path; and
determining path overhead of each target feasible path, and selecting a feasible path with lowest path overhead as a deterministic forwarding path of the service data.

2. The satellite network deterministic route construction method according to claim 1, wherein the transmission configuration information of the service data comprises: a long-term average rate of service data transmission, the maximum burst of service data transmission, an end-to-end delay requirement and the maximum length of service data packets of each priority.

3. The satellite network deterministic route construction method according to claim 1, wherein the topology information of the satellite network comprises:
the maximum bandwidth of an output port of each satellite node;
the maximum distribution bandwidth of each priority queue in the output port of each satellite node;
a credit value accumulation rate and a credit value sending rate of token buckets of each priority queue of a credit based shaper (CBS);
a size of the maximum buffer area of each priority queue in the output port of each satellite node; and
an inter-satellite node link propagation delay.

4. The satellite network deterministic route construction method according to claim 1, wherein the according to the transmission configuration information of the service data, and the topology information of the entire satellite network, screening out, from the plurality of feasible paths, a feasible path satisfying a preset transmission demand as a present target feasible path comprises:
determining whether a total delay required by forwarding the service data according to each of the plural feasible paths meets an end-to-end delay requirement of the service data from the source node to the destination node; the total delay required by forwarding the service data comprising: a sum of maximum delays of the priority queues passing through the satellite nodes and a sum of inter-satellite node propagation delays;
if feasible paths meeting the end-to-end delay requirement of forwarding of the service data exist, determining whether a bandwidth resource required by forwarding the service data according to each of the feasible paths meeting the end-to-end delay requirement of forwarding of the service data meets the maximum distribution bandwidth of the priority queue of each satellite node; the bandwidth resource being used for representing a sum of an occupied bandwidth of the priority queue of each satellite node through which the service data is forwarded and an average rate of forwarding of the service data;
if feasible paths meeting the maximum distribution bandwidth of the priority queue of each satellite node exist, determining whether a buffer area resource required by forwarding the service data according to each of the feasible paths meeting the maximum distribution bandwidth of the priority queue of each satellite node meets a maximum distribution buffer area of the priority queue of each satellite node; the buffer area resource being used for representing a sum of a size of a buffer area occupied by the priority queue of each satellite node through which the service data is forwarded and the maximum burst of service data transmission; and
screening out feasible queues meeting the end-to-end delay requirement of forwarding of the service data, the maximum distribution bandwidth of the priority queue of each satellite node and the maximum distribution buffer area of the priority queue of each satellite node.

5. The satellite network deterministic route construction method according to claim 1, wherein the according to the transmission configuration information of the service data, and the topology information of the entire satellite network, screening out, from the plurality of feasible paths, a feasible path satisfying a preset transmission demand as a present target feasible path further comprises: sequentially screening out, from the plural feasible paths, the feasible paths satisfying the preset transmission demand of the service data according to an ascending order of the total propagation delays of the feasible paths.

6. The satellite network deterministic route construction method according to claim 1, wherein the determining path overhead of each target feasible path comprises:
calculating a difference of the size of the occupied buffer area of a specified priority queue in the satellite node before and after the target feasible path is mapped to the specified priority queue;
dividing the difference by the size of the maximum distribution buffer area of the specified priority queue and then the maximum burst of the service data transmission to obtain path overhead of the specified priority queue; and
calculating a sum of the path overhead of the priority queues specified in the satellite nodes indicated in the target feasible path to obtain the path overhead of the target feasible path.

7. A satellite network deterministic route forwarding method, comprising:
executing a satellite network deterministic route construction method to obtain the deterministic forwarding path of the service data, satellite network deterministic route construction method comprising: collecting in real-time transmission configuration information of service data to be transmitted in a satellite network, and topology information of the entire satellite network in a global view of the satellite network, and continuously recording change data of the global view of the satellite network; according to the service data and the topology information, searching for a plurality of feasible paths from the source node to the destination node corresponding to each piece of the service data; according to the transmission configuration information of the service data, and the topology information of the entire satellite network, screening out, from the plurality of feasible paths, a feasible path satisfying a preset transmission demand as a present target feasible path; and determining path overhead of each target feasible path, and selecting a feasible path with lowest path overhead as a deterministic forwarding path of the service data;
issuing a service data packet carrying the service data and the deterministic forwarding path of the service data to the source node of the service data, and deducting, in the global view, the occupied bandwidth and the occupied buffer area on the priority queue specified in each satellite node through which the deterministic forwarding path of the service data passes;
after each satellite node specified by the deterministic forwarding path forwards the service data according to the deterministic forwarding path to forward the service data from the source node to the destination node, re-releasing, in the global view, the bandwidth and the buffer area occupied on the priority queue specified in each satellite node through which the deterministic forwarding path of the service data passes.

8. The satellite network deterministic route forwarding method according to claim 7, wherein the transmission configuration information of the service data comprises: a long-term average rate of service data transmission, the maximum burst of service data transmission, an end-to-end delay requirement and the maximum length of service data packets of each priority.

9. The satellite network deterministic route forwarding method according to claim 7, wherein the topology information of the satellite network comprises:
the maximum bandwidth of an output port of each satellite node;
the maximum distribution bandwidth of each priority queue in the output port of each satellite node;
a credit value accumulation rate and a credit value sending rate of token buckets of each priority queue of a credit based shaper (CBS);
a size of the maximum buffer area of each priority queue in the output port of each satellite node; and
an inter-satellite node link propagation delay.

10. The satellite network deterministic route forwarding method according to claim 7, wherein the according to the transmission configuration information of the service data, and the topology information of the entire satellite network, screening out, from the plurality of feasible paths, a feasible path satisfying a preset transmission demand as a present target feasible path comprises:
determining whether a total delay required by forwarding the service data according to each of the plural feasible paths meets an end-to-end delay requirement of the service data from the source node to the destination node; the total delay required by forwarding the service data comprising: a sum of maximum delays of the priority queues passing through the satellite nodes and a sum of inter-satellite node propagation delays;
if feasible paths meeting the end-to-end delay requirement of forwarding of the service data exist, determining whether a bandwidth resource required by forwarding the service data according to each of the feasible paths meeting the end-to-end delay requirement of forwarding of the service data meets the maximum distribution bandwidth of the priority queue of each satellite node; the bandwidth resource being used for representing a sum of an occupied bandwidth of the priority queue of each satellite node through which the service data is forwarded and an average rate of forwarding of the service data;
if feasible paths meeting the maximum distribution bandwidth of the priority queue of each satellite node exist, determining whether a buffer area resource required by forwarding the service data according to each of the feasible paths meeting the maximum distribution bandwidth of the priority queue of each satellite node meets a maximum distribution buffer area of the priority queue of each satellite node; the buffer area resource being used for representing a sum of a size of a buffer area occupied by the priority queue of each satellite node through which the service data is forwarded and the maximum burst of service data transmission; and
screening out feasible queues meeting the end-to-end delay requirement of forwarding of the service data, the maximum distribution bandwidth of the priority queue of each satellite node and the maximum distribution buffer area of the priority queue of each satellite node.

11. The satellite network deterministic route forwarding method according to claim 7, wherein the according to the transmission configuration information of the service data, and the topology information of the entire satellite network, screening out, from the plurality of feasible paths, a feasible path satisfying a preset transmission demand as a present target feasible path further comprises: sequentially screening out, from the plural feasible paths, the feasible paths satisfying the preset transmission demand of the service data according to an ascending order of the total propagation delays of the feasible paths.

12. The satellite network deterministic route forwarding method according to claim 7, wherein the determining path overhead of each target feasible path comprises:
calculating a difference of the size of the occupied buffer area of a specified priority queue in the satellite node before and after the target feasible path is mapped to the specified priority queue;
dividing the difference by the size of the maximum distribution buffer area of the specified priority queue and then the maximum burst of the service data transmission to obtain path overhead of the specified priority queue; and
calculating a sum of the path overhead of the priority queues specified in the satellite nodes indicated in the target feasible path to obtain the path overhead of the target feasible path.

13. A satellite network deterministic route system, comprising a processor and a memory, wherein the memory has computer instructions stored therein, the processor is configured to execute the computer instructions stored in the memory, and when the computer instructions are executed by the processor, the system implements the following steps:
collecting in real-time transmission configuration information of service data to be transmitted in a satellite network, and topology information of the entire satellite network in a global view of the satellite network, and continuously recording change data of the global view of the satellite network;
according to the service data and the topology information, searching for a plurality of feasible paths from the source node to the destination node corresponding to each piece of the service data;
according to the transmission configuration information of the service data, and the topology information of the entire satellite network, screening out, from the plurality of feasible paths, a feasible path satisfying a preset transmission demand as a present target feasible path; and
determining path overhead of each target feasible path, and selecting a feasible path with lowest path overhead as a deterministic forwarding path of the service data.

14. The satellite network deterministic route system according to claim 12, wherein the transmission configuration information of the service data comprises: a long-term average rate of service data transmission, the maximum burst of service data transmission, an end-to-end delay requirement and the maximum length of service data packets of each priority.

15. The satellite network deterministic route system according to claim 12, wherein the topology information of the satellite network comprises:
the maximum bandwidth of an output port of each satellite node;
the maximum distribution bandwidth of each priority queue in the output port of each satellite node;
a credit value accumulation rate and a credit value sending rate of token buckets of each priority queue of a credit based shaper (CBS);
a size of the maximum buffer area of each priority queue in the output port of each satellite node; and
an inter-satellite node link propagation delay.

16. The satellite network deterministic route system according to claim 12, wherein the according to the transmission configuration information of the service data, and the topology information of the entire satellite network, screening out, from the plurality of feasible paths, a feasible path satisfying a preset transmission demand as a present target feasible path comprises:
determining whether a total delay required by forwarding the service data according to each of the plural feasible paths meets an end-to-end delay requirement of the service data from the source node to the destination node; the total delay required by forwarding the service data comprising: a sum of maximum delays of the priority queues passing through the satellite nodes and a sum of inter-satellite node propagation delays;
if feasible paths meeting the end-to-end delay requirement of forwarding of the service data exist, determining whether a bandwidth resource required by forwarding the service data according to each of the feasible paths meeting the end-to-end delay requirement of forwarding of the service data meets the maximum distribution bandwidth of the priority queue of each satellite node; the bandwidth resource being used for representing a sum of an occupied bandwidth of the priority queue of each satellite node through which the service data is forwarded and an average rate of forwarding of the service data;
if feasible paths meeting the maximum distribution bandwidth of the priority queue of each satellite node exist, determining whether a buffer area resource required by forwarding the service data according to each of the feasible paths meeting the maximum distribution bandwidth of the priority queue of each satellite node meets a maximum distribution buffer area of the priority queue of each satellite node; the buffer area resource being used for representing a sum of a size of a buffer area occupied by the priority queue of each satellite node through which the service data is forwarded and the maximum burst of service data transmission; and
screening out feasible queues meeting the end-to-end delay requirement of forwarding of the service data, the maximum distribution bandwidth of the priority queue of each satellite node and the maximum distribution buffer area of the priority queue of each satellite node.

17. The satellite network deterministic route system according to claim 12, wherein the according to the transmission configuration information of the service data, and the topology information of the entire satellite network, screening out, from the plurality of feasible paths, a feasible path satisfying a preset transmission demand as a present target feasible path further comprises:
sequentially screening out, from the plural feasible paths, the feasible paths satisfying the preset transmission demand of the service data according to an ascending order of the total propagation delays of the feasible paths.

18. The satellite network deterministic route system according to claim 12, wherein the determining path overhead of each target feasible path comprises:
calculating a difference of the size of the occupied buffer area of a specified priority queue in the satellite node before and after the target feasible path is mapped to the specified priority queue;
dividing the difference by the size of the maximum distribution buffer area of the specified priority queue and then the maximum burst of the service data transmission to obtain path overhead of the specified priority queue; and
calculating a sum of the path overhead of the priority queues specified in the satellite nodes indicated in the target feasible path to obtain the path overhead of the target feasible path.
